(19) United States
(12) Patent Application Publication
(10) Pub. No.: US 2009/0297141 A1
(43) Pub. Date: Dec. 3, 2009

(54) Transmission apparatus, path testing method, and storage medium

(75) Inventors: Toshifumi Amano, Kawasaki (JP); Masakazu Bamba, Kawasaki (JP); Kanji Naito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/318,313

(22) Filed: Dec. 24, 2008

(30) Foreign Application Priority Data
May 30, 2008 (JP) 2008-142918

(51) Int. Cl. H04B 10/08; H04L 12/26

(52) U.S. Cl. 398/17; 370/248

(57) ABSTRACT

A transmission apparatus in a network where a path is set up is disclosed that includes a processing part configured to transmit a frame of the network to an egress node of the path when being set as an ingress node of the path, the frame having setup information of the path written therein, and to loop back the frame when being set as the egress node, the frame having response information written therein based on the setup information read from the frame, the response information indicating that the path is set up correctly.

### BACKGROUND OF THE INVENTION

1. Field of the Invention

The present invention relates generally to transmission apparatuses, and more particularly to a transmission apparatus in a network where a path is set up, a method of testing the path, and a storage medium storing a program to be executed in the transmission apparatus.

2. Description of the Related Art

Generalized Multiprotocol Label Switching (GMPLS) is a technique that newly adds a logical network, that is, a control plane that controls a data plane, to an already constructed physical network (or data plane where data actually flow) of Synchronous Optical Network (SONET), Synchronous Digital Hierarchy (SDH), or Wavelength Division Multiplexing (WDM), thereby unifying the management of SONET, SDH, or WDM signals and IP network signals, which have conventionally been managed separately. GMPLS makes it possible to set up a path with ease.

According to GMPLS, information is exchanged between adjacent nodes using multiple protocols such as Link Manager Protocol (LMP), Open Shortest Path First-Traffic Engineering (OSPF-TE), and Resource Reservation Protocol-Traffic Engineering (RSVP-TE), and all nodes share information on the connection destination node(s) of each node and the amount of data transmittable or receivable in the available band of each node. Each node autonomously operates using this information so that a communications channel (path) can be constructed.

FIG. 1 is a diagram illustrating a network 510 in which a path is set up by GMPLS. In order to communicate a signal between any two points, an egress (exit) node 513 is specified for an ingress (entrance) node 511 that serves as an entrance for a signal, and an instruction is given to set up a path by GMPLS. In response to this as a trigger, a signal path up to the egress node 513 is computed using information shared among relay nodes 512A through 512G, and RSVP messages of GMPLS are exchanged, thereby setting up the path. In FIG. 1, the ingress node 511 and the egress node 513 are connected through the relay nodes 512A, 512B, 512C, and 512D.

FIG. 2 is a sequence diagram illustrating a path setup in GMPLS. In FIG. 2, the ingress node 511 and the egress node 513 correspond to those of FIG. 1. Further, the relay nodes 512A through 512D of FIG. 1 are collectively shown as “relay node 512” for facilitation of description.

When a path setup is started in step S1001, in step S1002, the ingress node 511 transmits a path message (Path MSG) to the relay node 512. In step S1003, the relay node 512 automatically computes an intermediate signal path, and forwards (transfers) the path message (Path MSG) to the egress node 513. In response to reception of this path message (Path MSG), in step S1004, the egress node 513 sets up its own cross-connection (XCON). Then, in step S1005, the egress node 513 transmits a response (reservation) message (Resv MSG) to the relay node 512. In response to reception of this response message (Resv MSG), in step S1006, the relay node 512 (each relay node 512) sets up its own cross-connection (XCON). Then, in step S1007, the relay node 512 forwards (transfers) the response (reservation) message (Resv MSG) to the ingress node 511. In response to reception of this response message, in step S1008, the ingress node 511 sets up its own cross-connection (XCON). Thereby, in step S1009, the path setup is completed.

Thus, according to a path setup by GMPLS, each node autonomously operates and performs calculation to determine a signal path, thereby setting up a path. Therefore, there is the advantage that the location of an intervening (intermediate) relay node, the mounting status of various interface boards, and the connection status of an optical fiber are transparent to a user.

Japanese Laid-Open Patent Application No. 2007-259315 and Japanese Laid-Open Patent Application No. 2006-211263 each describe application of GMPLS to a TDM (Time Division Multiplex) network.

However, the GMPLS protocol does not go so far as to ensure normal construction of a path for signal communications. Therefore, actually, signals may not be communicated due to occurrence of some kind of failure although a path is established on the protocol. Therefore, it is desirable to test path communication after setting up a path by GMPLS.

Failure of this GMPLS signal communication requires a troublesome operation of specifying a point where a problem has occurred, collecting information from a corresponding node, and connecting a tester and performing information collecting such as checking a signal condition to remove the cause of the problem, deleting a path, and resetting a path.

This specification and handling of a failure point require information that has been transparent in setting up a path by GMPLS, such as the position of a relay node or its implementation condition. This negates the advantage of GMPLS that a path can be set up with transparency of a relay node.

### SUMMARY OF THE INVENTION

Embodiments of the present invention may solve or reduce one or more of the above-described problems.

According to one embodiment of the present invention, a transmission apparatus, a path testing method, and a storage medium storing a program to be executed in the transmission apparatus are provided in which one or more of the above-described problems may be solved or reduced.

According to one embodiment of the present invention, there is provided a transmission apparatus in a network in which a path is set up, the transmission apparatus including a processing part configured to transmit a frame of the network to an egress node of the path when being set as an ingress node of the path, the frame having setup information of the path written therein, and to loop back the frame when being set as the egress node, the frame having response information written therein based on the setup information read from the frame, the response information indicating that the path is set up correctly.

According to one embodiment of the present invention, there is provided a path testing method in a network where a path is set up, the path testing method including the steps of an ingress node of the path transmitting a frame of the network to an egress node of the path, the frame having setup information of the path written therein; and the egress node writing response information into the frame in response to reception of the frame, and looping back the frame.

According to one embodiment of the present invention, there is provided a storage medium storing a program for causing a computer to execute a path testing method in a network where a path is set up, the path testing method including the steps of an ingress node of the path transmitting a frame of the network to an egress node of the path, the frame having setup information of the path written therein; and the egress node writing response information into the frame in response to reception of the frame, and looping back the frame.

According to one aspect of the present invention, a transmission apparatus transmits a frame of a network to an egress node of a path when set as the ingress node of the path, the frame having the setup information of the path written therein, and loops back the frame when set as the egress node, the frame having response information indicating that the path is set up correctly written therein based on the setup information read from the frame. As a result, it is possible to conduct a path test with ease.

### BRIEF DESCRIPTION OF THE DRAWINGS

Other objects, features and advantages of the present invention will become more apparent from the following detailed description when read in conjunction with the accompanying drawings, in which:

FIG. 1 is a diagram illustrating a GMPLS network;

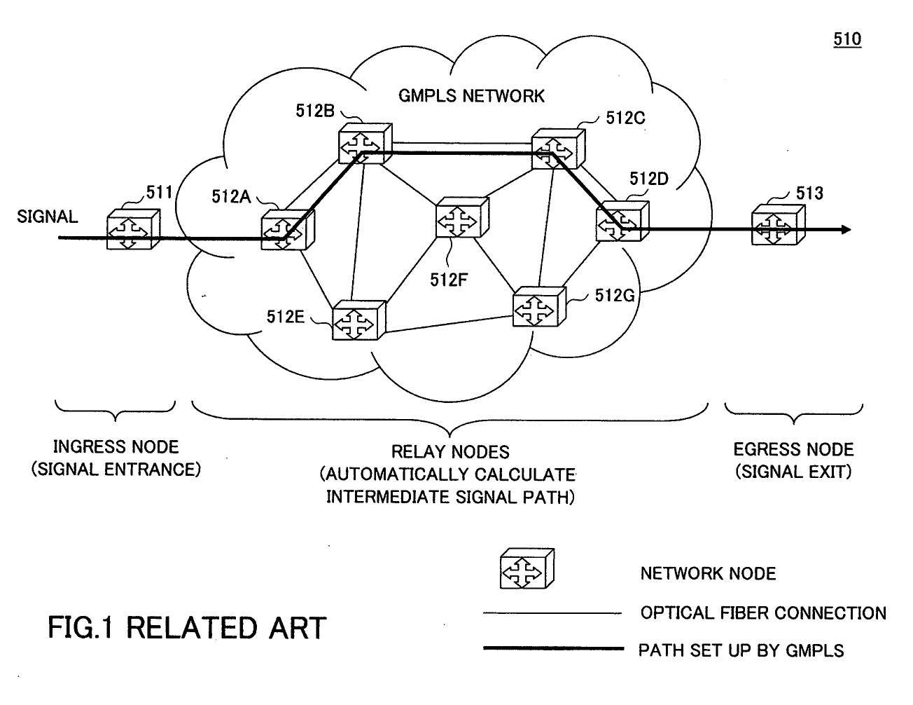

FIG. 2 is a sequence diagram illustrating a path setup in GMPLS;

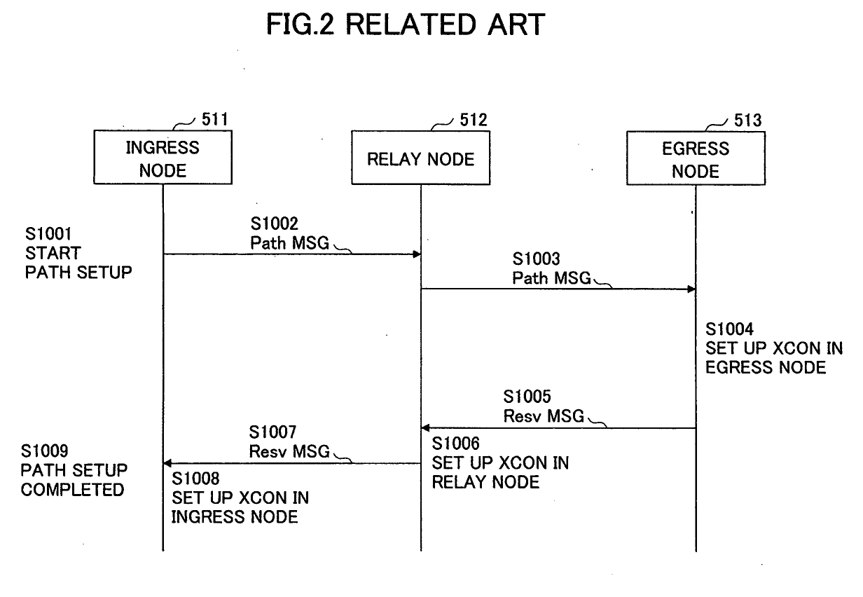

FIG. 3 is a diagram illustrating a GMPLS network according to an embodiment of the present invention;

FIG. 4 is a sequence diagram illustrating a path setup automatic test of GMPLS (at the time of a normal end) according to the embodiment of the present invention;

FIG. 5 is a diagram illustrating a path overhead (POH) of SONET according to the embodiment of the present invention;

FIG. 6 is a diagram illustrating the format of a J1 byte according to the embodiment of the present invention;

FIG. 7 is a functional block diagram illustrating an ingress node (at the time of the start of a path setup or at the time of the start of a path setup automatic test) according to the embodiment of the present invention;

FIG. 8 is a functional block diagram illustrating a relay node (at the time of the start of a path setup or at the time of the start of a path setup automatic test) according to the embodiment of the present invention;

FIG. 9 is a functional block diagram illustrating an egress node (at the time of the start of a path setup or at the time of the start of a path setup automatic test) according to the embodiment of the present invention;

FIG. 10 is a block diagram illustrating the relay node (at the time of reception of a path setup response or at the time of reception of a path test response) according to the embodiment of the present invention;

FIG. 11 is a block diagram illustrating the ingress node (at the time of reception of a path setup response or at the time of reception of a path test response) according to the embodiment of the present invention;

FIG. 12 is a flowchart illustrating a GMPLS path setup automatic test according to the embodiment of the present invention;

FIG. 13 is a sequence diagram illustrating a GMPLS path setup automatic test (abnormal end time MODE1) according to the embodiment of the present invention;

FIG. 14 is a sequence diagram illustrating a GMPLS path setup automatic test (abnormal end time MODE2) according to the embodiment of the present invention;

FIG. 15 is a sequence diagram illustrating a GMPLS path setup automatic test (abnormal end time MODE3) according to the embodiment of the present invention; and

FIG. 16 is a block diagram illustrating a hardware configuration of the ingress node according to the embodiment of the present invention.

### DETAILED DESCRIPTION OF THE PREFERRED EMBODIMENTS

A description is given below, with reference to the accompanying drawings, of an embodiment of the present invention.

According to this embodiment, the communication of a path set up by GMPLS on a SONET network is tested using the trace function of SONET with the loopback of a SONET frame having GMPLS setup information set in path overhead (POH). In the following description, it is assumed that a GMPLS path is set up on a SONET network. However, it is also possible to set up a GMPLS path on an SDH network or a WDM network in another embodiment.

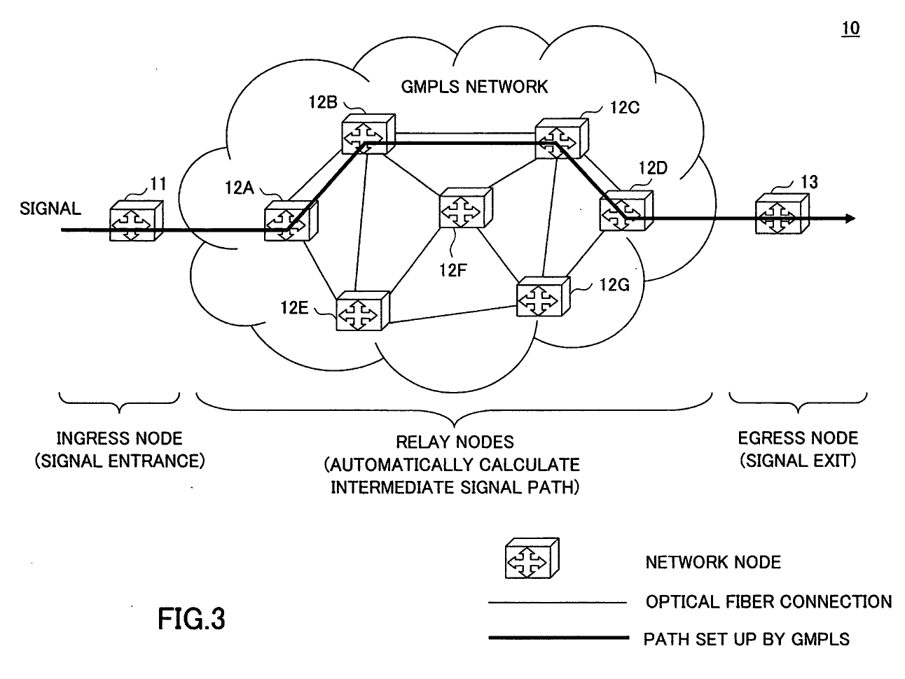

FIG. 3 is a diagram illustrating a network 10 in which a path is set up by GMPLS according to this embodiment. In order to communicate a signal between any two points, an egress (exit) node 13 is specified for an ingress (entrance) node 11 that serves as an entrance for a signal, and an instruction is given to set up a path by GMPLS. In response to this as a trigger, a signal path up to the egress node 13 is computed using information shared among relay nodes 12A through 12G, and RSVP messages of GMPLS are exchanged, thereby setting up the path. In FIG. 3, the ingress node 11 and the egress node 13 are connected through the relay nodes 12A, 12B, 12C, and 12D.

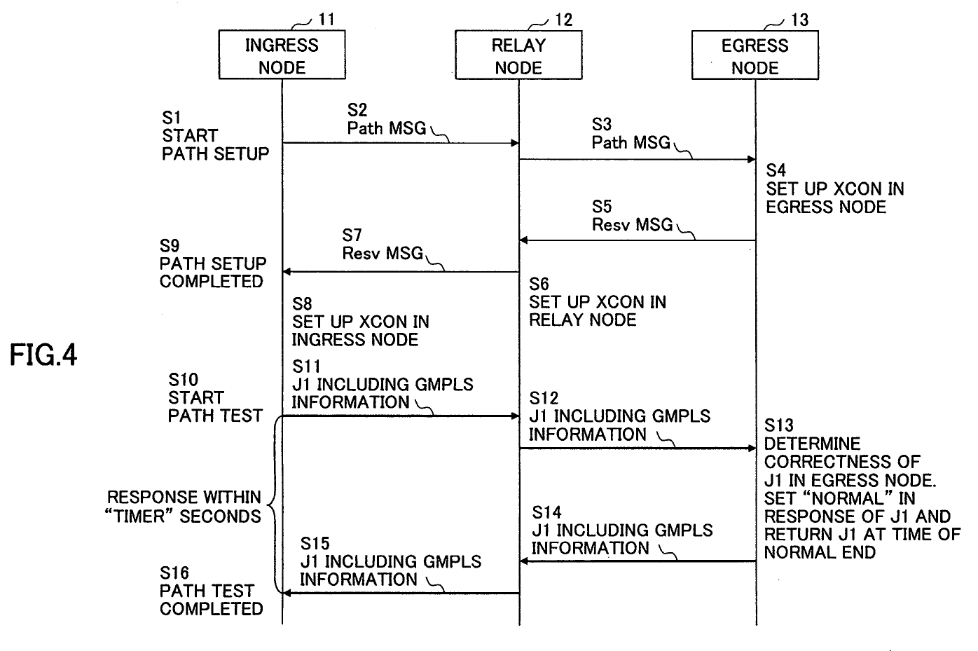

FIG. 4 is a sequence diagram illustrating a path setup automatic test of GMPLS (at the time of a normal end) according to this embodiment. In FIG. 4, the ingress node 11 and the egress node 13 correspond to those of FIG. 3. Further, the relay nodes 12A through 12D of FIG. 3 are collectively shown as “relay node 12” for facilitation of description, but the “relay node 12” may also represent a single relay node.

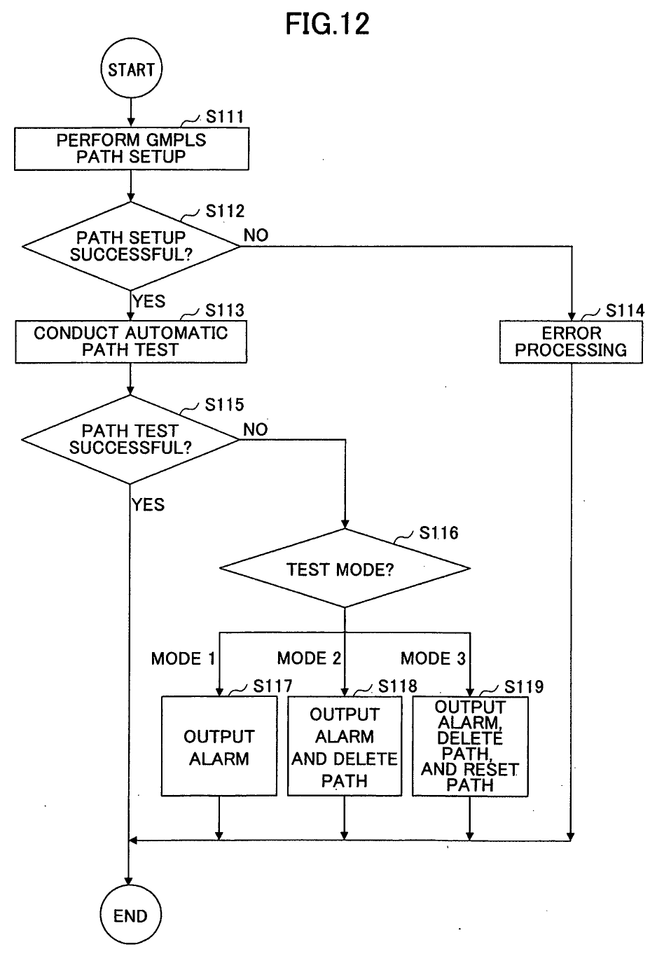

A description is given below, with reference to FIG. 4, of operations of the ingress node 11, the relay node 12, and the egress node 13 in the case where a path test ends normally according to this embodiment. The sequence illustrated in FIG. 4 is a normal end route shown by steps S111, S112 (YES), S113, and S115 (YES) in the flowchart of FIG. 12.

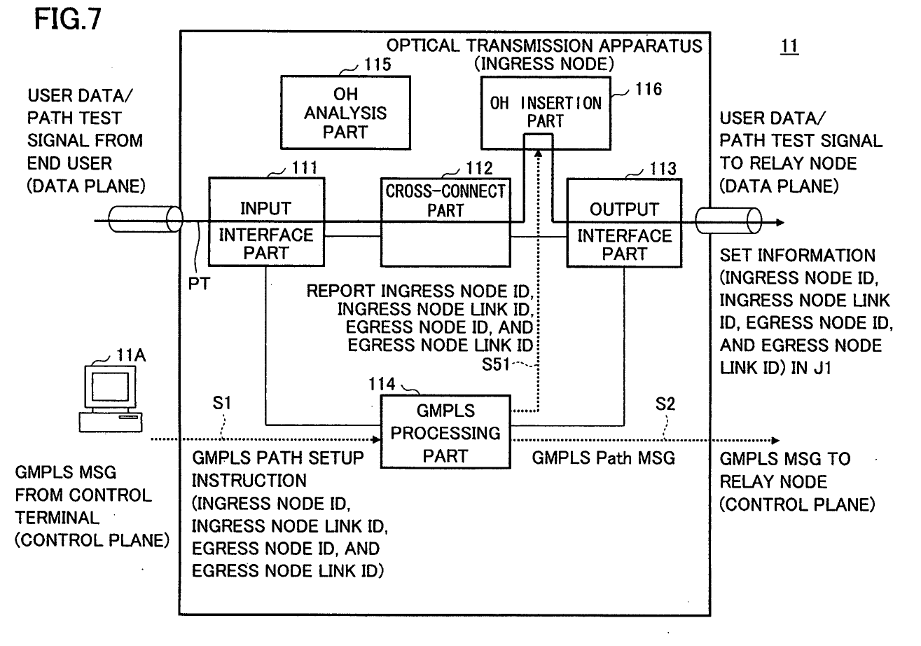

In the case of setting up a path from the ingress node 11 to the egress node 13, in step S1, a user transmits a GMPLS message (GMPLS MSG) from a control terminal 11A (FIG. 7) to the ingress node 11 through a control plane, thereby giving an instruction to set up a path. In response to reception of this path setup request, in step S2, the ingress node 11 transmits a GMPLS path message (Path MSG) to the relay node 12 through the control plane. As described above, in FIG. 4, the relay node 12 represents multiple relay nodes. In this case, each relay node transmits a path message of RSVP, which is one of the protocols of GMPLS, to a relay node to which a path is to be set up based on the results of path calculations. In step S3, the relay node 12 transmits a path message to the egress node 13.

Here, a description is given of a signaling system according to RSVP. As illustrated in FIG. 4, in response to reception of a path connecting (setup) request from the control terminal 11A (FIG. 7), the ingress node 11 sends a path message toward the egress node 13 in order to check the availability of a path (band). In response to reception of the path message, the relay node 12 (for example, the relay node 12A in FIG. 3) checks the availability of a channel for a requested band. If a channel is available, the relay node 12 sends a path message to the next relay node. If a channel is not available, the relay node 12 transmits a path error message (Path Error) toward the ingress node 11. If channels are available for the requested band in all nodes through to the egress node 13, the egress node 13 actually reserves the available channel for the requested band, and sets up a path. The egress node 13 sends a reservation message (Resv MSG) to a node in the direction of the ingress node 11 (for example, the relay node 12D in FIG. 3). In response to reception of this reservation message, an intervening (intermediate) node (for example, the relay node 12C in FIG. 3) performs path connecting (cross-connecting) in accordance with the reservation message, and sends a reservation message to the next intervening node. The subsequent operation is performed in the same manner, and finally, in response to reception of the reservation message as a trigger, the ingress node 11 performs path connecting. Thereby, a path is set up.

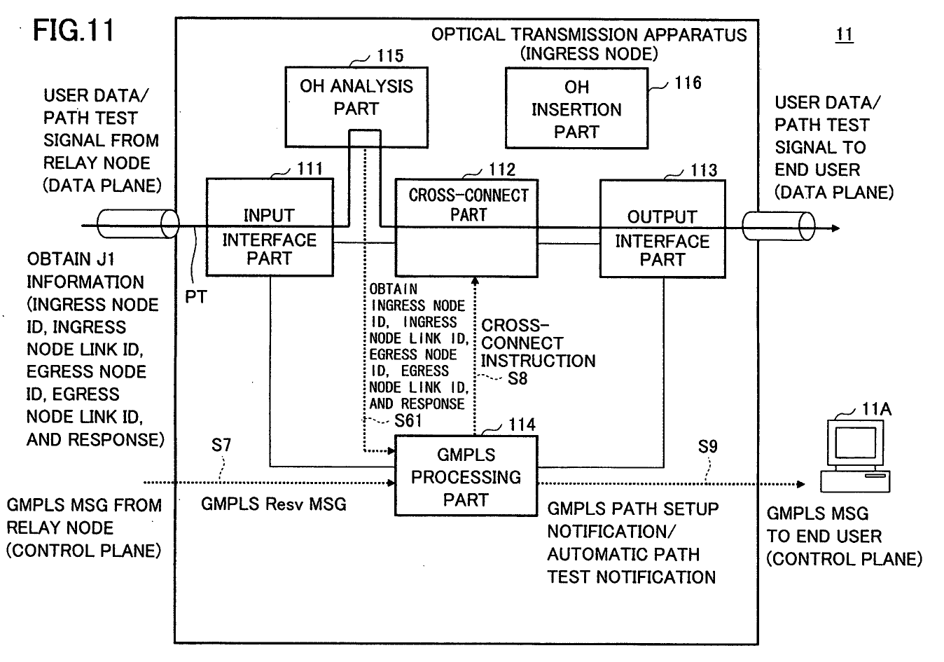

In response to reception of the path message from the relay node 12, in step S4, the egress node 13 sets up its own cross-connection (XCON). Then, in step S5, the egress node 13 transmits an RSVP reservation message (Resv MSG) indicating completion of reservation of a band necessary for setting up a path by the cross-connection to the relay node 12. In response to reception of the RSVP reservation message from the egress node 13, in step S6, the relay node 12 sets up its own cross-connection (XCON). Then, in step S7, the relay node 12 transmits an RSVP reservation message (Resv MSG) indicating completion of reservation of a band necessary for setting up a path by the cross-connection to the ingress node 11. In response to reception of the RSVP reservation message from the relay node 12, in step S8, the ingress node 11 sets up its own cross-connection. Then, in step S9, the ingress node 11 notifies the control terminal 11A (FIG. 11) of completion of a path setup. Setting up a path is completed at this point.

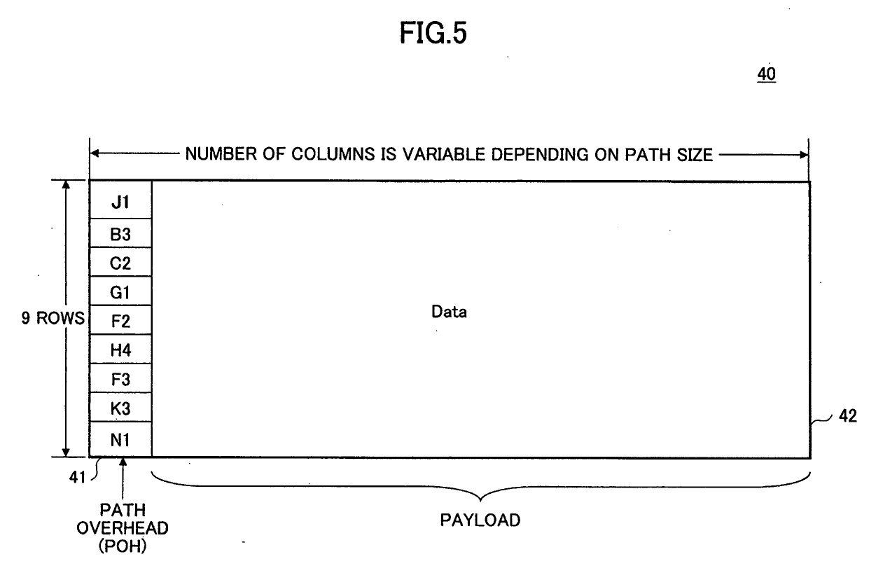

After setting up a path by GMPLS, a path test is conducted automatically in succession. According to this embodiment, the J1 byte of the POH defined by GR-253, which is one of standards of SONET transmission apparatuses, is used in the path test. FIG. 5 is a diagram illustrating a POH of SONET. A SONET frame 40 includes POH 41 and payload 42, which is data. POH is information generated at a point of path generation such as STS-1 or STS-3 and retained up to an end point or transmission destination of information. Employment of POH makes it possible to perform end-to-end monitoring of a bit error of information transmitted through the path. The details of the POH of SONET are as shown in Table 1 below.

TABLE 1

| POH | Usage Definition | Notes |
|---|---|---|
| J1 byte | Trace | 64 bytes. Used in |
| | | this embodiment. |
| B3 byte | BIP-8 | |
| C2 byte | Signal Label | |
| G1 byte | Path Status | |
| F2 byte | User Channel | |
| H4 byte | Indicator | |
| Z3 byte | Growth | |
| Z4 byte | Growth | |
| Z5 byte | Tandem Connection | |

In this automatic path test, the node ID and link ID of the ingress node 11 and the node ID and link ID of the egress node 13 both used in the GMPLS path setup are incorporated into the J1 byte. A signal including this J1 byte is transmitted from the ingress node 11 and received by the egress node 13. When the egress node 13 determines that the J1 byte is addressed to the egress node 13, the egress node 13 adds information indicating a normal response to the J1 byte, and returns the J1 byte to the ingress node 11 (a loopback of the J1 byte). When the ingress node 11 receives the returned signal and the information indicating a normal response is included in the J1 byte, the path test ends normally. That is, this indicates that a path is set up correctly. Thereby, it is possible to check or confirm a match between a path setup on GMPLS and a path setup on SONET, so that it is possible to ensure signal communication.

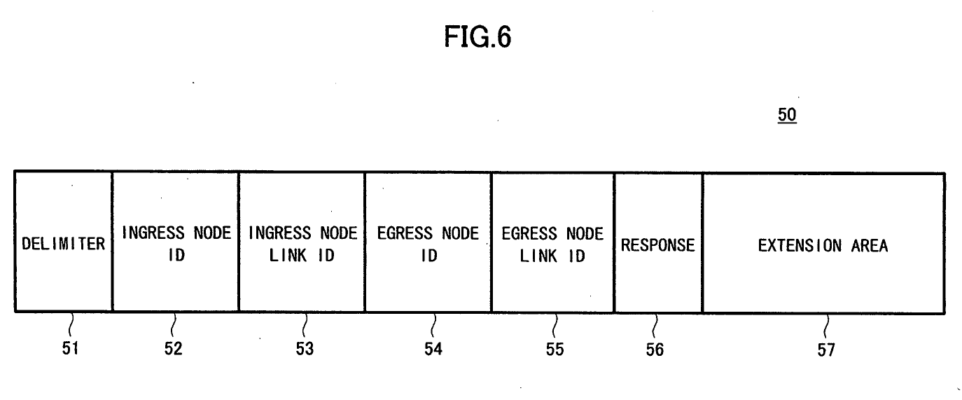

FIG. 6 is a diagram illustrating the format of the J1 byte. Referring to FIG. 6, the J1 byte includes the following areas: a delimiter 51 (indicating the delimiter of the J1 byte), an ingress node ID 52 (indicating a GMPLS node ID indicating an ingress node), an ingress node link ID 53 (indicating a GMPLS link ID indicating a port of the ingress node unit), an egress node ID 54 (indicating a GMPLS node ID indicating an egress node), an egress node link ID 55 (indicating a GMPLS link ID indicating a port of the egress node unit), a response 56 (indicating a path test response), and an extension area 57 (indicating a reserve area).

Returning to FIG. 4, in step S10, the ingress node 11 waits for enough time for each node to complete cross-connecting, and starts a path test. In step S11, the ingress node 11 sets its node ID, its link ID, the node ID of the egress node 13, and the link ID of the egress node 13 in the J1 byte of the path overhead of a path test signal, and transmits the path test signal to the relay node 12 through a data plane. In response to reception of the path test signal from the ingress node 11, in step S12, the relay node 12 transmits the path test signal to the egress node 13.

In response to reception of the path test signal (frame) from the relay node 12, in step S13, the egress node 13 checks and determines the correctness of the egress node ID 54 and the egress node link ID 55 (FIG. 6) included in the J1 byte, and the egress node 13 sets information indicating a correct path setup in the response 56 (FIG. 6) of the J1 byte. Then, in step S14, the egress node 13 returns the J1 byte to the relay node 12 (a loopback of the J1 byte).

In response to reception of a path test signal including the GMPLS information in the J1 byte from the egress node 13, in step S15, the relay node 12 transmits the path test signal to the ingress node 11. In response to reception of the path test signal from the relay node 12, in step S16, the ingress node 11 reads the GMPLS information included in the J1 byte, and determines that information indicating a correct path setup is set in the response 56 (FIG. 6) of the J1 byte. Thereby, the path test is completed.

Next, a description is given in more detail, with reference to FIG. 7 through FIG. 11, of each step of a path setup and a path setup automatic test according to this embodiment.

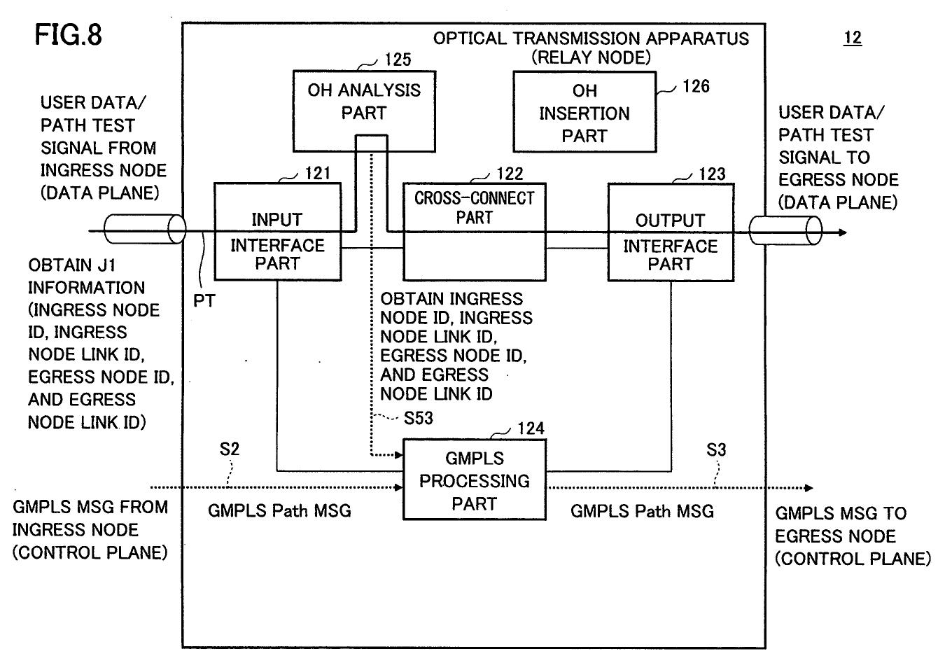

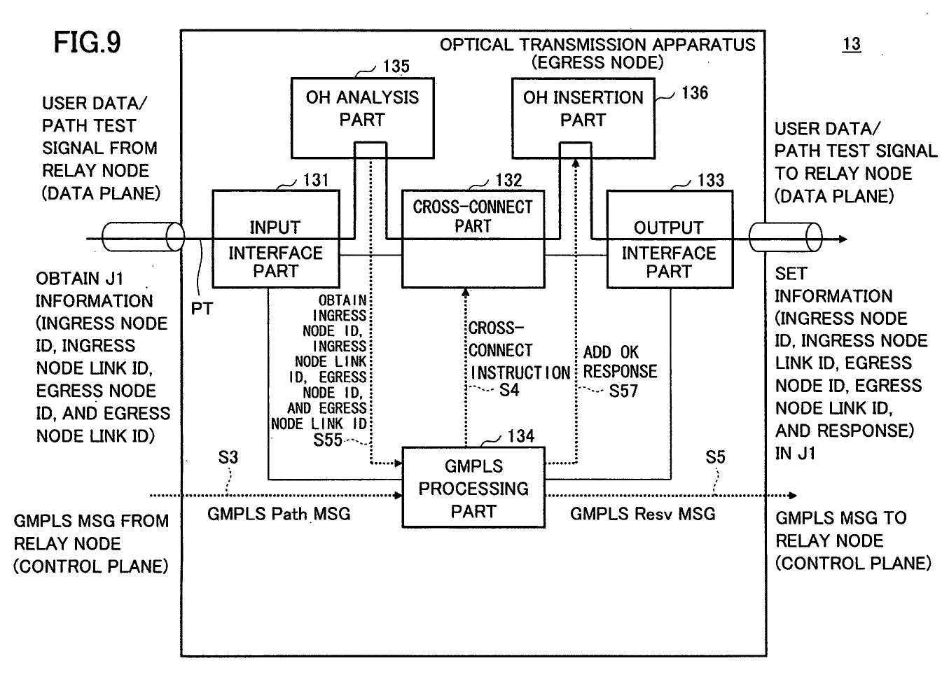

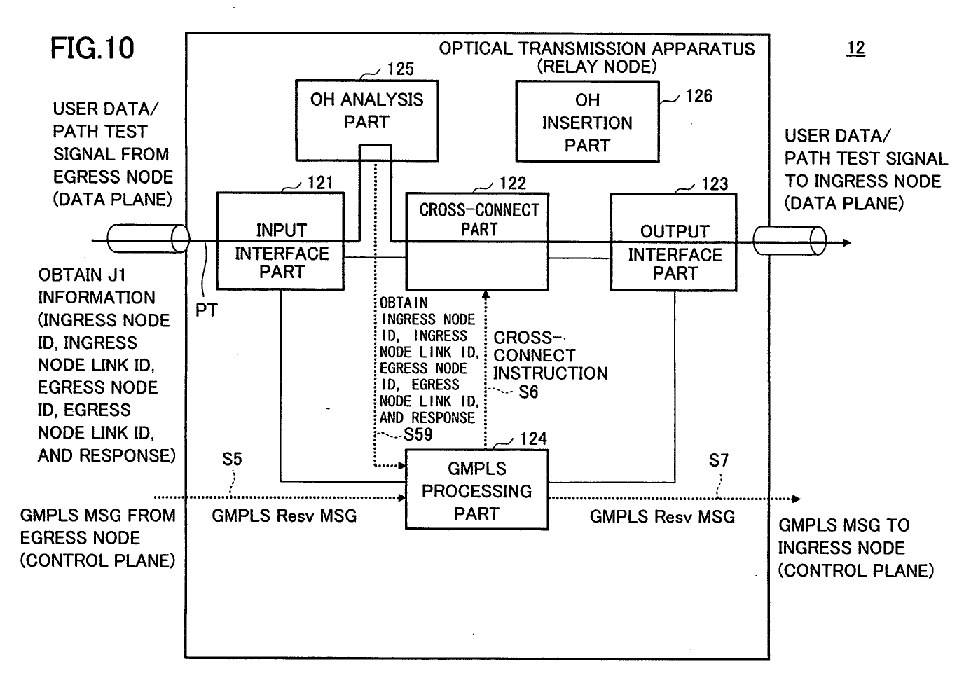

FIG. 7 is a functional block diagram illustrating the ingress node 11 (at the time of the start of a path setup or at the time of the start of a path setup automatic test). FIG. 8 is a functional block diagram illustrating the relay node 12 (at the time of the start of a path setup or at the time of the start of a path setup automatic test). FIG. 9 is a functional block diagram illustrating the egress node 13 (at the time of the start of a path setup or at the time of the start of a path setup automatic test). FIG. 10 is a block diagram illustrating the relay node 12 (at the time of reception of a path setup response or at the time of reception of a path test response). FIG. 11 is a block diagram illustrating the ingress node 11 (at the time of reception of a path setup response or at the time of reception of a path test response).

FIG. 7 through FIG. 11 illustrate optical transmission apparatuses of SONET. These transmission apparatuses operate as the ingress node 11, the relay node 12, and the egress node 13 of FIG. 4 based on their respective setups.

Referring to FIG. 7 and FIG. 11, the ingress node 11 includes an input interface part 111, a cross-connect part 112, an output interface part 113, a GMPLS processing part 114, an overhead (OH) analysis part 115, and an overhead (OH) insertion part 116. These parts 111 through 116 are connected so as to be able to communicate with one another. For simplification of graphical representation, however, only the connection between the GMPLS processing part 114 and each of the input interface part 111 and the output interface part 113 and the connection between the cross-connect part 112 and each of the input interface part 111 and the output interface part 113 are shown in FIG. 7 and FIG. 11.

Referring to FIG. 8 and FIG. 10, the relay node 12 includes an input interface part 121, a cross-connect part 122, an output interface part 123, a GMPLS processing part 124, an overhead (OH) analysis part 125, and an overhead (OH) insertion part 126. These parts 121 through 126 are connected so as to be able to communicate with one another. For simplification of graphical representation, however, only the connection between the GMPLS processing part 124 and each of the input interface part 121 and the output interface part 123 and the connection between the cross-connect part 122 and each of the input interface part 121 and the output interface part 123 are shown in FIG. 8 and FIG. 10.

Referring to FIG. 9, the egress node 13 includes an input interface part 131, a cross-connect part 132, an output interface part 133, a GMPLS processing part 134, an overhead (OH) analysis part 135, and an overhead (OH) insertion part 136. These parts 131 through 136 are connected so as to be able to communicate with one another. For simplification of graphical representation, however, only the connection between the GMPLS processing part 134 and each of the input interface part 131 and the output interface part 133 and the connection between the cross-connect part 132 and each of the input interface part 131 and the output interface part 133 are shown in FIG. 9.

In the following description, steps corresponding to those of FIG. 4 are referred to by the same step numbers.

(a) Path Setup Request to Ingress Node 11

Referring to FIG. 7, in the case of setting up a path from the ingress node 11 to the egress node 13, in step S1, a user makes a GMPLS path setup request to the ingress node 11 from the control terminal 11A through a control plane. The GMPLS processing part 114 of the ingress node 11 receives this path setup request. This path setup request includes the node ID and the link ID of the ingress node 11 and the node ID and the link ID of the egress node 13 as path setup information. Further, the path setup request includes the setting of a mode that determines an operation at the time of an abnormal end of the path test and the setting of the response waiting time TIMER of the path test. (A detailed description is given below, with reference to FIG. 12 and the subsequent drawings.) For example, the default setting of the mode is MODE1, and the default setting of the response waiting time TIMER is 5 seconds.

(b) Processing of Ingress Node 11

Referring to FIG. 7, in response to reception of the path setup request from the control terminal 11A, in step S2, the GMPLS processing part 114 of the ingress node 11 performs path computation, and transmits a path message (Path MSG) of RSVP, which is one of the protocols of GMPLS, to an appropriate relay node 12 through a control plane based on the result of the path computation.

(c) Processing of Relay Node 12

Referring to FIG. 8, in response to reception of the path message from the ingress node 11 through the control plane, in step S3, the GMPLS processing part 124 of the relay node 12 transmits a path message of RSVP, which is one of the protocols of GMPLS, to the egress node 13. Here, if there are multiple relay nodes 12 as illustrated in FIG. 3, for example, the relay node 12 A performs path computation, and transmits a path message to an appropriate relay node 12 (relay node 12B) based on the result of the path computation. Subsequently, a path message is transmitted in the same manner, and finally, the last relay node 12D transmits a path message to the egress node 13.

(d) Processing of Egress Node 13

Referring to FIG. 9, in response to reception of the path message from the relay node 12 through the control plane, in step S4, the GMPLS processing part 134 of the egress node 13 instructs the cross-connect part 132 to set up a cross-connection (XCON). As a result, a cross-connection (XCON) is established between the input interface part 131 and the output interface part 133 of the egress node 13. Then, in step S5, the GMPLS processing part 134 transmits an RSVP reservation message (Resv MSG) indicating that a band necessary for setting up a path has been reserved by the cross-connection to the relay node 12 through the control plane.

(e) Processing of Relay Node 12

Referring to FIG. 10, in response to reception of the reservation message from the egress node 13, in step S6, the GMPLS processing part 124 of the relay node 12 instructs the cross-connect part 122 to set up a cross-connection (XCON). As a result, a cross-connection (XCON) is established between the input interface part 121 and the output interface part 123 of the egress node 12. Then, in step S7, the GMPLS processing part 124 transmits an RSVP reservation message (Resv MSG) indicating that a band necessary for setting up a path has been reserved by the cross-connection to the ingress node 11 through the control plane. Here, if there are multiple relay nodes 12 as illustrated in FIG. 3, for example, the relay node 12D sets up a cross-connection and transmits a reservation message to the relay node 12C. The subsequent operation is performed in the same manner, and finally, the last relay node 12A sets up a cross-connection and transmits a reservation message to the ingress node 11.

(f) Processing of Ingress Node 11

Referring to FIG. 11, in response to reception of the reserve message from the relay node 12, in step SB, the GMPLS processing part 114 of the ingress node 11 instructs the cross-connect part 112 to set up a cross-connection (XCON). As a result, a cross-connection (XCON) is established between the input interface part 111 and the output interface part 113 of the egress node 11. Then, in step S9, the GMPLS processing part 114 notifies the control terminal 11A of completion of a path setup through the control plane.

(g) Processing of Ingress Node 11

Referring back to FIG. 7, the ingress node 11 waits for enough time for each node to complete cross-connecting, and starts a path test (step S10 of FIG. 4). In step S51, the GMPLS processing part 114 of the ingress node 11 passes the node ID and the link ID of the ingress node 11 and the node ID and the link ID of the egress node 13 used in GMPLS to the overhead (OH) insertion part 116, and has them set in the J1 byte of the path overhead of a path test signal (frame) PT. The GMPLS processing part 114 transmits this path test signal PT through the output interface part 113 to the relay node 12 via a data plane (step S11 of FIG. 4).

(h) Processing of Relay Node 12

Referring back to FIG. 8, the interface part 121 of the relay node 12 receives the path test signal PT from the ingress node 11. Then, the overhead (OH) analysis part 125 extracts the node ID and the link ID of the ingress node 11 (the ingress node ID 52 and the ingress node link ID 53 of FIG. 6) and the node ID and the link ID of the egress node 13 (the egress node ID 54 and the egress node link ID 55 of FIG. 6) from the path overhead of the path test signal PT, and passes them to the GMPLS processing part 124 in step S53. The GMPLS processing part 124 checks the set egress node. In this case, since the GMPLS processing part 124 is informed that its apparatus (the relay node 12) is not an egress node, the GMPLS processing part 124 transmits the path test signal PT through the cross-connect part 122 and the output interface part 123 to the egress node 13 via the data plane (step S12 of FIG. 4).

(i) Processing of Egress Node 13

Referring back to FIG. 9, the input interface part 131 of the egress node 13 receives the path test signal PT from the relay node 12. The overhead (OH) analysis part 135 extracts the node ID and the link ID of the ingress node 11 (the ingress node ID 52 and the ingress node link ID 53 of FIG. 6) and the node ID and the link ID of the egress node 13 (the egress node ID 54 and the egress node link ID 55 of FIG. 6) from the path overhead of the path test signal PT, and passes them to the GMPLS processing part 134 in step S 55. Then, the GMPLS processing part 134 checks the set egress node. In this case, the GMPLS processing part 134 is informed that its apparatus (the egress node 13) is an egress node. Since the egress node ID 54 and the egress node link ID 55 included in the J1 byte of the path overhead of the path test signal PT match the node ID and the link ID, respectively, of the egress node 13 managed by the GMPLS processing part 134, the GMPLS processing part 134 can confirm the match between the information on the path set up by GMPLS and the information on the path set up by cross-connections and can confirm that a signal has been communicated from the ingress node 11 to the egress node 13 (step S13 of FIG. 4).

Next, in step S57 (part of step S13), the GMPLS processing part 134 of the egress node 13 instructs the overhead (OH) insertion part 136 to set OK (response information) in the response 56 (FIG. 6) of the J1 byte of the path overhead of the path test signal PT in order to indicate that a path has been set up correctly and a signal has been communicated from the ingress node 11 to the egress node 13 as a result of the path test. As a result, OK (response information) is set in the J1 byte of the path overhead of the path test signal PT. Then, the GMPLS processing part 134 transmits (loops back) the path test signal PT through the output interface part 133 to the relay node 12 via the data plane (step S14 of FIG. 4).

(j) Processing of Relay Node 12

Referring back to FIG. 10, the input interface part 121 of the relay node 12 receives the path test signal PT from the egress node 13. The overhead (OH) analysis part 125 extracts the node ID and the link ID of the ingress node 11 (the ingress node ID 52 and the ingress node link ID 53 of FIG. 6), the node ID and the link ID of the egress node 13 (the egress node ID 54 and the egress node link ID 55 of FIG. 6), and the response information (the response 56 of FIG. 6) from the path overhead of the path test signal PT, and passes them to the GMPLS processing part 124 in step S59. The GMPLS processing part 124 checks the set ingress node. In this case, since the GMPLS processing part 124 is informed that its apparatus (the relay node 12) is not an ingress node, the GMPLS processing part 124 transmits the path test signal PT through the cross-connect part 122 and the output interface part 123 to the ingress node 11 via the data plane (step S15 of FIG. 4).

(k) Processing of Ingress Node 11

Referring back to FIG. 11, the input interface part 111 of the ingress node 11 receives the path test signal PT from the relay node 12. The overhead (OH) analysis part 115 extracts the node ID and the link ID of the ingress node 11 (the ingress node ID 52 and the ingress node link ID 53 of FIG. 6), the node ID and the link ID of the egress node 13 (the egress node ID 54 and the egress node link ID 55 of FIG. 6), and the response information (the response 56 of FIG. 6) from the path overhead of the path test signal PT, and passes them to the GMPLS processing part 114 in step S61. Then, the GMPLS processing part 114 checks the set ingress node. In this case, since the ingress node ID 52 and the ingress node link ID 53 included in the J1 byte of the path overhead of the path test signal PT match the node ID and the link ID, respectively, of the ingress node 11 managed by the GMPLS processing part 114, the GMPLS processing part 134 determines that its apparatus is the ingress node. Further, the GMPLS processing part 134 determines from the response information (the response 56 of FIG. 6) that the path test has ended normally. The GMPLS processing part 114 notifies the control terminal 11A of completion of the path test via the control plane. Further, the path test signal PT is transmitted to the end user through the cross-connect part 112 and the output interface part 113 in the data plane (step S16 of FIG. 4).

FIG. 12 is a flowchart illustrating a GMPLS path setup automatic test according to this embodiment. First, in step S11, a path is set up on a network by GMPLS through a control plane. In step S112, it is determined whether the path has been set up successfully. If the path has not been set up successfully (NO in step S112), in step S114, error processing is performed.

If the path has been set up successfully (YES in step S112), in step S113, an automatic path test is conducted as described above with reference to FIG. 4 through FIG. 11. In step S115, it is determined whether the path test has succeeded. If the path test has succeeded (YES in step S115), the path setup automatic test of this embodiment ends.

If the path test has not succeeded (No in step S115), in step S116, the test mode is checked, and the processing proceeds to a corresponding mode based on the result of the check. FIG. 12 shows three test modes MODE1, MODE2, and MODE3. In another embodiment, a mode different from those may be executed.

In the case of MODE1, in step S117, an alarm that notifies the user of a failure of the path test is output to the user. In the case of MODE2, in step S118, in addition to the outputting of the alarm, the set-up path is deleted through the control plane. In MODE3, in step S119, in addition to the outputting of the alarm and deletion of the set-up path through the control plane, the path is set up again through the control plane. Then, the path setup automatic test of this embodiment ends.

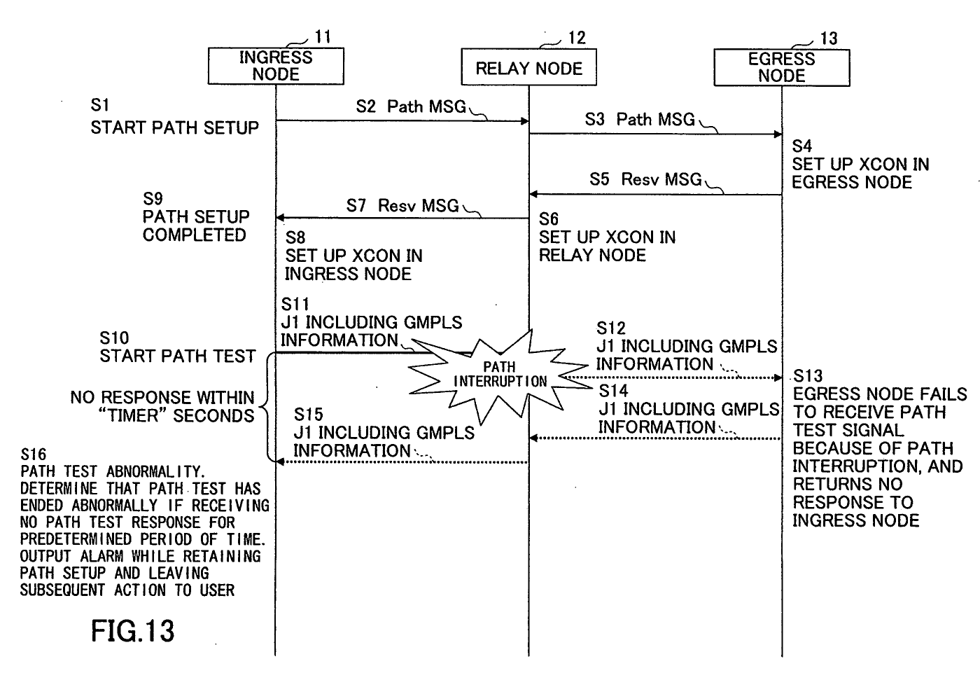

Next, a description is given, with reference to FIG. 13 through FIG. 15, of operations of the ingress node 11, the relay node 12, and the egress node 13 in the case where it is determined that the path test has failed in step S115.

FIG. 13 is a diagram illustrating the case where the mode for the time when a path test fails and ends abnormally is MODE1 (FIG. 12). In FIG. 13, step S1 through step S11 are the same as those of FIG. 4, and a description thereof is omitted. Here, it is assumed that the mode for determining the operation at the time of a path test abnormal end, set at the time of making a path setup request to the ingress mode 11, is MODE1.

Consideration is given to the case where the path thought to have been set up by GMPLS is not set up correctly (or interrupted) because of a failure that has occurred for some reason between the ingress node 11 and the relay node 12 or between relay nodes 12 (for example, between the relay node 12A and the relay node 12B) in the case where there are multiple relay nodes 12.

In this case, step S12 through step S15 described above with reference to FIG. 4 are not performed. In FIG. 13, steps S12 through S15 are indicated by broken lines to show that these steps are not performed.

The ingress node 11 waits for transmission (a loopback) of the path test signal PT in which response information is set in the response 56 area (FIG. 6) of the J1 byte of the path overhead from the relay node 12. If a predetermined period of time (the response waiting time TIMER of a path test set at the time of making a path setup request to the ingress node 11) passes without reception of the path test signal PT, the ingress node 11 determines that a time-out has occurred, and performs abnormal-time processing. In this case, in step S16, the ingress node 11 outputs an alarm indicating an abnormal end of the path test to the control terminal 11A (FIG. 6) to alert the user, while retaining the path setup as it is and leaving a subsequent action to the user.

In the above-described embodiment, the ingress node 11 determines the occurrence of a time-out, and performs an abnormality operation. In another embodiment, the egress node 13 may determine the occurrence of a time-out and perform an abnormality operation. For example, the egress node 13 may determine that a time-out has occurred and perform abnormal-time processing unless receiving the path test signal PT from the ingress node 11 within a predetermined period of time since setting up a cross-connection in the egress node 13 (step S4) after receiving a path message from the relay node 12 (step S3). In this case, the egress node 13 outputs an alarm indicating an abnormal end of the path test to alert the user, while retaining the path setup as it is and leaving a subsequent action to the user.

Further, in yet another embodiment, the relay node 12 may determine the occurrence of a time-out and perform abnormal-time processing. For example, the relay node 12 may determine that a time-out has occurred and perform abnormal-time processing unless receiving the path test signal PT from the ingress node 11 within a predetermined period of time since setting up a cross-connection in the relay node 12 (step S6) after receiving a reservation message from the egress node 13 (step S5). In this case, the relay node 12 outputs an alarm indicating an abnormal end of the path test to alert the user, while retaining the path setup as it is and leaving a subsequent action to the user.

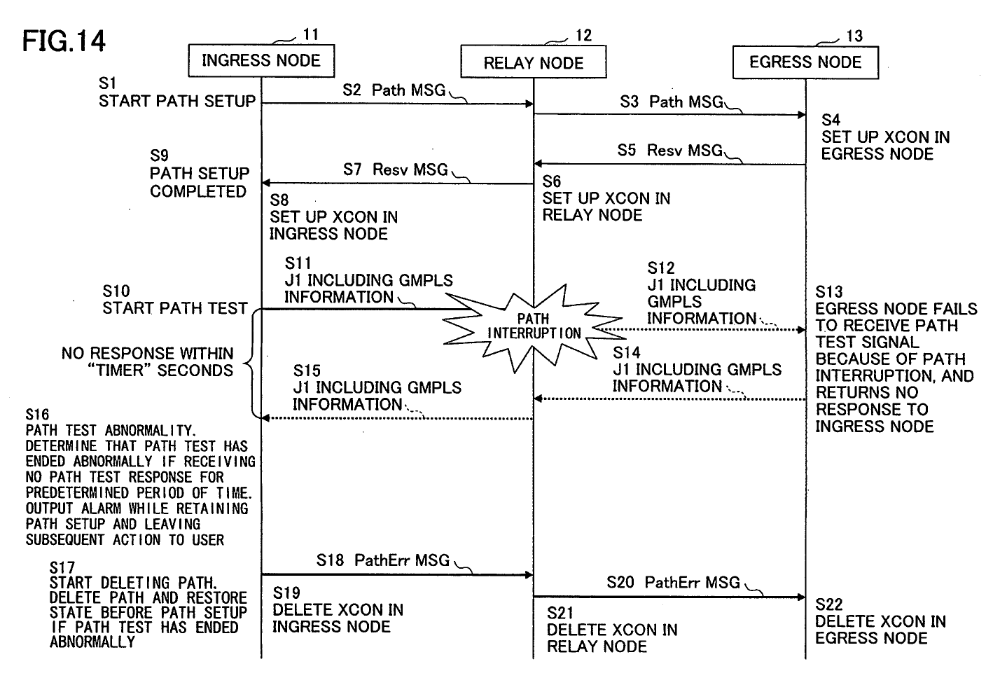

FIG. 14 is a diagram illustrating the case where the mode for the time when a path test fails and ends abnormally is MODE2 (FIG. 12). In FIG. 14, step S1 through step S16 are the same as those of FIG. 13, and a description thereof is basically omitted. Here, it is assumed that the mode for determining the operation at the time of a path test abnormal end, set at the time of making a path setup request to the ingress mode 11, is MODE2.

In step S16, the ingress node 11 determines that a time-out has occurred and performs abnormal-time processing unless receiving the path test signal PT from the relay node 12 within a predetermined period of time. In this case, the path setup is normal at the GMPLS level but abnormal at the SONET level. The ingress node 11 outputs an alarm indicating an abnormal end of the path test to alert the user, and restores the conditions existing before the path setup by deleting the path set up by GMPLS.

For this, in step S18, the ingress node 11 transmits a path error message (PathErr MSG) to the relay node 12 through the control plane. This message is for deleting a path according to the RSVP protocol used in GMPLS. Then, in step S19, the ingress node 11 deletes the cross-connection set up in the ingress node 11.

In response to reception of the path error message from the ingress node 11, in step S20, the relay node 12 transmits the path error message (PathErr MSG) to the egress node 13 via the control plane. As described above, this message is for deleting a path according to the RSVP protocol used in GMPLS. In step S21, the relay node 12 deletes the cross-connection set up in the relay node 12.

In response to reception of the path error message from the relay node 12, in step S22, the egress node 13 deletes the cross-connection set up in the egress node 13 without further forwarding the path error message because the egress node 13 is an egress node.

As a result, the path set up by GMPLS is completely deleted, and the original conditions are restored.

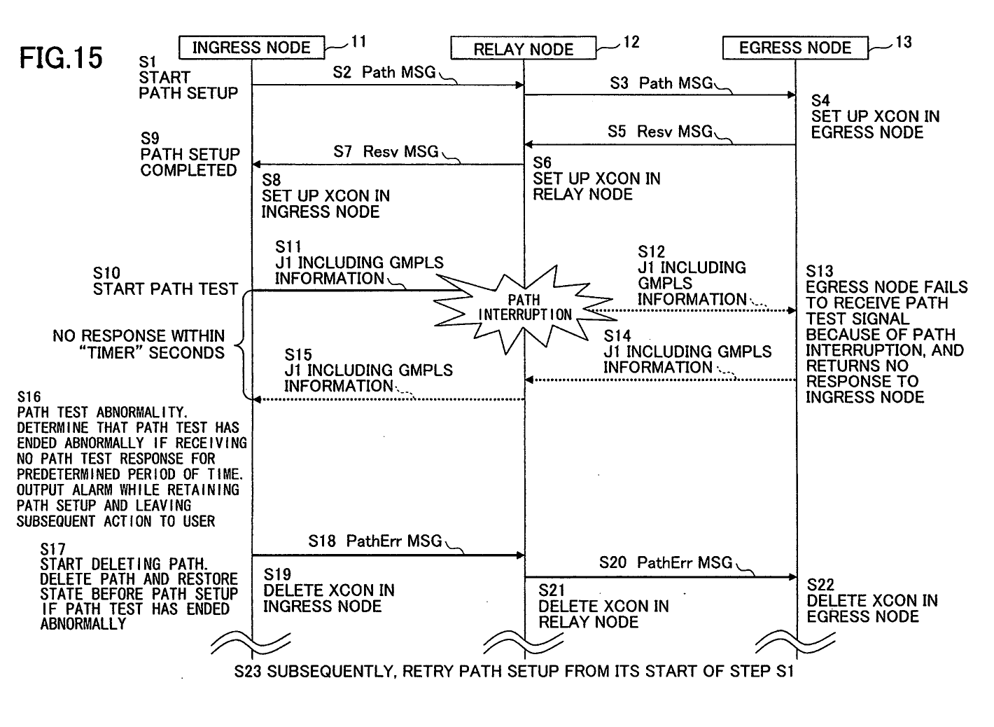

FIG. 15 is a diagram illustrating the case where the mode for the time when a path test fails and ends abnormally is MODE3 (FIG. 12). In FIG. 15, step S1 through step S22 are the same as those of FIG. 14, and a description thereof is basically omitted. Here, it is assumed that the mode for determining the operation at the time of a path test abnormal end, set at the time of making a path setup request to the ingress mode 11, is MODE3.

In step S23, the ingress node 11 retries the path setup from its start of step S1 in order to reset the path. As a result, even if a path setup by GMPLS fails once, the path setup by GMPLS is automatically retried.

Thus, according to one embodiment of the present invention, a path test is automatically conducted after setting up a path, so that it is possible to easily confirm signal communication (conduct a path test). Since the parameters used in GMPLS are used as they are, it is possible to check a match between the path setup by GMPLS and the path setup by SONET or SDH and to ensure signal communication. Further, it is also possible to prevent such a problem as mistaking an object of testing because of an operational mistake. The operation at the time of an abnormal end of the path test follows a preset mode. This mode makes it possible to automatically output an alarm, delete a path, and reset the path, so that it is possible to reduce the network operation workload of a client.

The above embodiment is described on the assumption that SONET is used. SDH is standardized as a unified international interface by ITU-T based on SONET. SDH is based on the same technology as SONET, and has the same basic frame configuration as SONET at 156 Mbps or higher. Accordingly, it is also possible to implement the above-described embodiment on an SDH network.

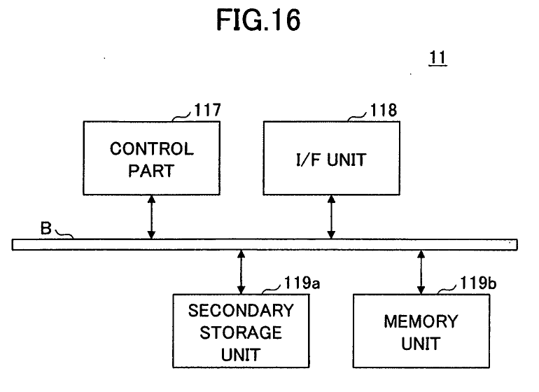

FIG. 16 is a block diagram illustrating a hardware configuration of the ingress node 11. The relay node 12 and the egress node 13 may have the same hardware configuration as illustrated in FIG. 16.

Referring to FIG. 16, the ingress node 11 includes a control part 117, an interface (I/F) unit 118, a secondary storage unit 119 a, and a memory unit 119b, which are interconnected with a bus B. The control part 117 may be a CPU, a microprocessor, or a microcontroller, and controls the operation of the ingress node 11. The interface (I/F) unit 118 serves as the input interface and the output interface of the ingress node 11. The secondary storage unit 119a may be, for example, a hard disk drive (HDD). The memory unit 119b may include a read-only memory (ROM) and a random-access memory (RAM).

The method illustrated in FIG. 4, FIG. 13, FIG. 14, or FIG. 15 may be implemented as a computer program executed in the control parts (117) of the ingress node 11, the relay node 12, and the egress node 13. Further, the computer program may be contained in the ROM or HDD (storage medium) of each of the ingress node 11, the relay node 12, and the egress node 13 so as to be read out and executed by the corresponding control part (117).

According to one aspect of the present invention, a transmission apparatus transmits a frame of a network to an egress node of a path when set as the ingress node of the path, the frame having the setup information of the path written therein, and loops back the frame when set as the egress node, the frame having response information indicating that the path is set up correctly written therein based on the setup information read from the frame. As a result, it is possible to conduct a path test with ease.

The present invention is not limited to the specifically disclosed embodiment, and variations and modifications may be made without departing from the scope of the present invention.

The present application is based on Japanese Priority Patent Application No. 2008-142918, filed on May 30, 2008, the entire contents of which are hereby incorporated by reference.

What is claimed is:

1. A transmission apparatus in a network where a path is set up, the transmission apparatus comprising:
a processing part configured to transmit a frame of the network to an egress node of the path when being set as an ingress node of the path, the frame having setup information of the path written therein, and to loop back the frame when being set as the egress node, the frame having response information written therein based on the setup information read from the frame, the response information indicating that the path is set up correctly.

2. The transmission apparatus as claimed in claim 1, wherein:
the path is set up by Generalized Multiprotocol Label Switching,
the network is of one of Synchronous Optical Network, Synchronous Digital Hierarchy, or Wavelength Division Multiplexing, and
the processing part is configured to write the setup information and the response information into a path overhead of the frame.

3. The transmission apparatus as claimed in claim 1, wherein the processing part is configured to determine that the path is not set up correctly in response to no loopback of the frame from the egress node within a predetermined period of time since the transmission of the frame to the egress node when the transmission apparatus is set as the ingress node of the path.

4. The transmission apparatus as claimed in claim 3, wherein the processing part is configured to delete the path after determining that the path is not set up correctly.

5. The transmission apparatus as claimed in claim 1, further comprising:
an insertion part configured to write the setup information and the response information into the frame.

6. The transmission apparatus as claimed in claim 1, further comprising:
an analysis part configured to read the setup information from the frame.

7. A path testing method in a network where a path is set up, the path testing method comprising the steps of:
an ingress node of the path transmitting a frame of the network to an egress node of the path, the frame having setup information of the path written therein; and
the egress node writing response information into the frame in response to reception of the frame, and looping back the frame.

8. The path testing method as claimed in claim 7, wherein:
the path is set up by Generalized Multiprotocol Label Switching,
the network is one of SONET, SDH, and WDM, and
the setup information and the response information are written in a path overhead of the frame.

9. The path testing method as claimed in claim 7, further comprising the step of:
the ingress node determining that the path is not set up correctly in response to no loopback of the frame from the egress node within a predetermined period of time since the transmission of the frame to the egress node.

10. The path testing method as claimed in claim 9, further comprising the step of:
the ingress node deleting the path after determining that the path is not set up correctly.

11. A storage medium storing a program for causing a computer to execute a path testing method in a network where a path is set up, the path testing method comprising the steps of:
an ingress node of the path transmitting a frame of the network to an egress node of the path, the frame having setup information of the path written therein; and
the egress node writing response information into the frame in response to reception of the frame, and looping back the frame.
